(19) United States
(12) Patent Application Publication
(10) Pub. No.: US 2007/0104989 A1
(43) Pub. Date: May 10, 2007

(54) Apparatus and method for heat exchange of liquid fuel type fuel cell system

(76) Inventor: Takahiro Kuriiwa, Yongin-si (KR)

Correspondence Address: STEIN, MCEWEN & BUI, LLP, 1400 EYE STREET, NW, SUITE 300, WASHINGTON, DC, 20005, US

(21) Appl. No.: 11/528,551

(22) Filed: Sep. 28, 2006

(30) Foreign Application Priority Data
Sep. 28, 2005 (KR) 2005-90741

(51) Int. Cl. H01M 8/04; H01M 8/12

(52) U.S. Cl. 429/26

(57) ABSTRACT

An apparatus and a method of heat exchange of a liquid fuel type fuel cell system. The apparatus includes: an electricity generating unit to generate electricity when a fuel is supplied to an anode and oxidizer is supplied to a cathode; a first flow path unit connected to an outlet of the cathode; a second flow path unit connected to an inlet of the anode; a heat exchanging unit to exchange thermal energy between fluids passing through the first flow path unit and the second flow path unit; a third flow path unit connected to the inlet on an anode and bypassing the heat exchanging unit; and a first valve to control flow ratios of fluids passing through the second flow path unit and the third flow path unit. The method of heat exchange includes: sensing the temperature of the electricity generating unit; and controlling a flow path of the third flow path unit depending on the temperature of the electricity generating unit.

### CROSS-REFERENCE TO RELATED APPLICATIONS

This application claims the benefit of Korean Patent Application No. 2005-90741, filed Sep. 28, 2005, in the Korean Intellectual Property Office, the disclosure of which is incorporated herein by reference.

### BACKGROUND OF THE INVENTION

1. Field of the Invention

Aspects of the present invention relate to a method of controlling a heat exchange which can decrease a warming-up time of a fuel cell and over-heating of the fuel cell, and a liquid fuel type fuel cell system using the same.

2. Description of the Related Art

A fuel cell is a power generation system to generate electric energy by electrochemically reacting hydrogen and oxygen. According to various sorts of electrolyte used, fuel cells can be categorized as phosphoric acid fuel cells, molten carbonate fuel cells, solid oxide fuel cells, polymer electrolyte fuel cells and alkaline fuel cells, etc. These respective fuel cells are basically operated based on the same principle, but are different in view of operating temperatures, and sorts of fuels, catalyzers and electrolytes, used, etc.

Among other advantages over other fuel cells, the polymer electrolyte membrane fuel cell (PEMFC) has a high output feature, a low operating temperature feature, and rapid starting and answering features, and is widely applicable to a mobile power source, such as portable electronic equipment or a transportable power source, such as a power source for automobiles as well as a distributed power source, such as a stationary power plant used in a house or a public building, etc.

Also, as a category of polymer electrolyte membrane fuel cells, there is a liquid fuel type fuel cell, which directly supplies a liquid methanol fuel to a fuel cell. The liquid fuel type fuel cell is termed a direct methanol fuel cell (DMFC). The liquid fuel type fuel cell is advantageous in view of miniaturization because it does not use a reformer, unlike other polymer electrolyte membrane fuel cells.

Generally, as shown in FIG. 1, the liquid fuel type fuel cell system includes a membrane electrode assembly (MEA) configured of a polymer electrolyte membrane 11 to selectively pass hydrogen ions; and an anode electrode 13 and a cathode electrode 15 closely adhered respectively to both sides of the polymer electrolyte membrane 11.

The liquid fuel type fuel cell system has a stack structure of a plurality of membrane electrode assemblies each functioning as a general fuel cell; and a plurality of separators 17 and 19 to supply fuel and air to the anode electrode 13 and the cathode electrode 15, respectively, and to collect electricity, and to allow liquid fuel such as methanol supplied by a liquid pump 30 from a fuel tank 20 to be electrochemically reacted with oxygen in the air supplied by a fan 40, etc., to generate electric energy.

Also, some of the conventional liquid fuel type fuel cell systems can use a mixing tank and a recycler. In this case, the mixing tank mixes and circulates non-reacted liquid fuel and water discharged from the stack to provide the mixture to the stack again, and the recycler, for example, is disposed so that it condenses a high temperature steam discharged from an outlet on a cathode side to provide the condensed steam to the mixing tank as liquid. According to such a construction as described above, the conventional liquid fuel type fuel cell system exhibits an improved efficiency.

However, such a conventional liquid fuel type fuel cell system as described above has disadvantages such as a warming-up time is long and the temperature of the stack rises excessively when operated for a long time. When the temperature of the stack rises excessively, the components of the stack such as the polymer electrolyte membrane may be damaged.

### SUMMARY OF THE INVENTION

It is an aspect of the present invention to provide a method of controlling a heat exchanger disposed to exchange heat between an outlet on a cathode side of a fuel cell and a fuel supply route on an anode side thereof.

It is another aspect of the present invention to provide a liquid fuel type fuel cell which can decrease a warming-up time of a fuel cell and an excessive temperature rising of the fuel cell by controlling a heat exchanger disposed to exchange heat between an outlet on a cathode side and a fuel supply route on an anode side using the method as above, and/or realize additional advantages.

In order to accomplish the above, according to one aspect of the present invention, there is provided a heat exchanger of a liquid fuel type fuel cell system including an electricity generating unit to generate electricity by an electrochemical reaction between fuel supplied to an anode electrode and oxidizer supplied to a cathode electrode, including: a first flow path unit connected to an outlet on the cathode electrode; a second flow path unit connected to an inlet on the anode electrode; a heat exchanging unit to exchange thermal energy between fluids passing through the first flow path unit and the second flow path unit; and a third flow path unit connected to the inlet on the anode electrode and bypassing the heat exchanging unit.

While not required in all aspects, preferably, the heat exchanger may further include a first valve to control a flow ratio of fluids passing through the second flow path unit and the third flow path unit. Also, the first valve is a valve to open/close a flow path of the third flow path unit. Also, the heat exchanger may further include a second valve to open/close a flow path of the second flow path unit. Also, the heat exchanger may further include a control device to control the opening or closing the flow path of the flow path units in response to the temperature sensed from a sensor.

According to a second aspect of the present invention, there is provided a method of heat exchange of a liquid fuel type fuel cell system in a heat exchanger including a first flow path unit connected to an outlet on a cathode electrode of a fuel cell; a second flow path unit connected to an inlet on an anode electrode of a fuel cell; and a third flow path unit connected to the inlet on the anode electrode and bypassing a heat exchanging unit, where the heat exchanging unit exchanges thermal energy between fluids passing through the first flow path unit and the second flow path unit, the method comprising: sensing the temperature of the electricity generating unit; controlling a flow path of the third flow path unit to be in a closed state, when the temperature of the electricity generating unit is below a reference temperature; and controlling a flow path of the third flow path unit to be in an open state, when the temperature of the electricity generating unit is the reference temperature or higher and below a critical temperature.

While not required in all aspects, preferably, when the temperature of the electricity generating unit is the critical temperature or higher, the method of heat exchange of the liquid fuel type fuel cell system further includes transmitting a control signal to limit the power required by a load connected to the electricity generating unit to a predetermined value or less to the load.

Also, when the temperature of the electricity generating unit is below the reference temperature, the method of heat exchange of the liquid fuel type fuel cell system further includes controlling a flow path of the second flow path unit to be in an open state; and when the temperature of the electricity generating unit is the reference temperature or higher, and below the critical temperature, the method of heat exchange of the liquid fuel type fuel cell system further includes controlling the flow path of the second flow path unit to be in an open state. Furthermore, when the temperature of the electricity generating unit is the critical temperature or higher, the method of heat exchange of the liquid fuel type fuel cell system further includes controlling the flow path of the second flow path unit to be in a closed state and controlling the flow path of the third flow path unit to be in an open state.

According to a third aspect of the present invention, there is provided a liquid fuel type fuel cell system including: an electricity generating unit including an electrolyte membrane and an anode electrode and a cathode electrode positioned on both sides of the electrolyte membrane to generate electricity by an electrochemical reaction between liquid fuel supplied to the anode electrode and oxidizer supplied to the cathode electrode; a sensor to sense the temperature of the electricity generating unit; and a heat exchanging unit including a first flow path unit connected to an outlet on the cathode electrode of the electricity generating unit and a second flow path unit connected to an inlet on the anode electrode of the electricity generating unit; a third flow path unit connected to the inlet on the anode electrode and bypassing the heat exchanging unit to exchange thermal energy between the first flow path unit and the second flow path unit; and a first control member to select a main flow path of fluids passing through the second flow path unit and the third flow path unit.

While not required in all aspects, preferably, the liquid fuel type fuel cell system further includes a second control member to control a flow path of the second flow path unit. Also, the liquid fuel type fuel cell system further includes a control device to control the first and second control members to control the flow paths of the first and second flow path units respectively, in response to the temperature sensed from the sensor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing a conventional direct methanol fuel cell system;

FIG. 2 is a block diagram showing a liquid fuel type fuel cell system including a heat exchanger according to a first embodiment of the present invention;

FIG. 3A to FIG. 3C are block diagrams showing three operation modes of the heat exchanger as shown in FIG. 2;

FIG. 4 is a flow chart showing the method of heat exchange of the liquid fuel type fuel cell system as shown in FIG. 2;

FIG. 5 is a block diagram showing a liquid fuel type fuel cell system including a heat exchanger according to a second embodiment of the present invention;

FIG. 6A to FIG. 6C are block diagrams showing three operation modes of the heat exchanger as shown in FIG. 5; and

FIG. 7 is a flow chart showing the method of heat exchange of the liquid fuel type fuel cell system as shown in FIG. 5.

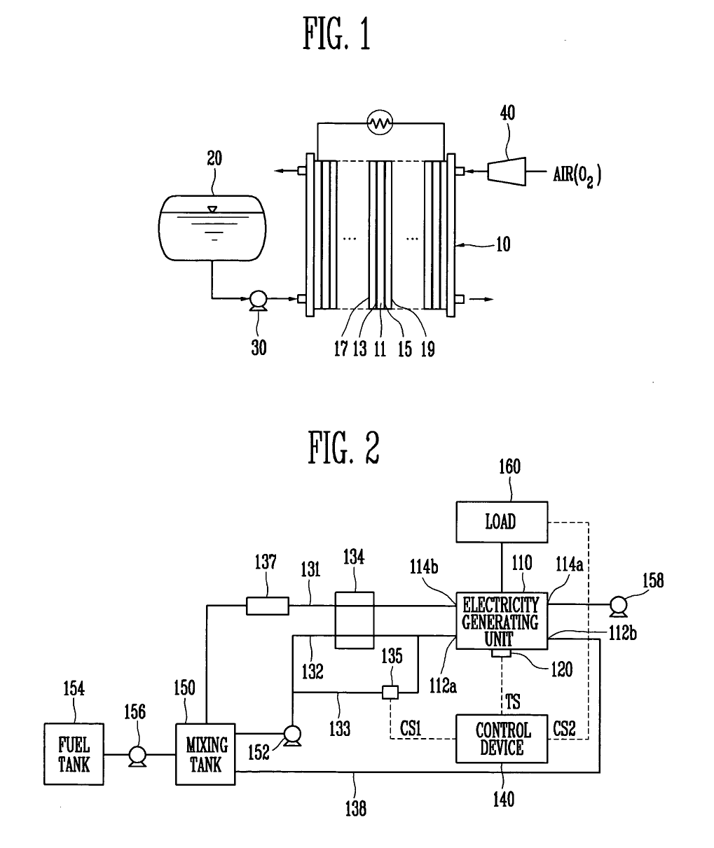

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

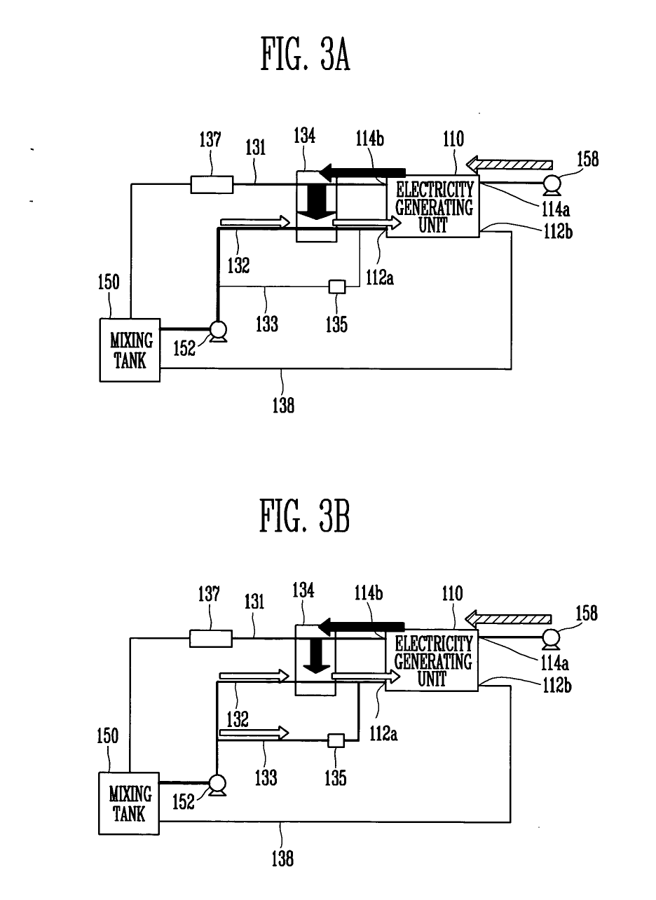

In the following description, a liquid fuel type fuel cell includes a direct methanol fuel cell (DMFC). FIG. 2 is a block diagram showing a liquid fuel type fuel cell system including a heat exchanger according to a first embodiment of the present invention. Referring to FIG. 2, the liquid fuel type fuel cell system includes an electricity generating unit 110, a sensor 120, a first flow path unit 131, a second flow path unit 132, a third flow path unit 133, a heat exchanging unit 134, a flow path control valve 135, a recycler 137, a control device 140 and a mixing tank 150. Here, the heat exchanger comprises a sensor 120, a first flow path unit 131, a second flow path unit 132, a third flow path unit 133, a heat exchanging unit 134, a flow path control valve 135 and a control device 140.

Describing the liquid fuel type fuel cell system in more detail, the electricity generating unit 110 is a power system to generate electric energy by electrochemically reacting fuel and oxidizer. The electricity generating unit 110 includes an anode inlet 112a to flow in fuel, an anode outlet 112b to discharge unreacted fuel and reaction products, a cathode inlet 114a to flow in oxidizer and a cathode outlet 114b to discharge unreacted oxidizer and reaction products. The fuel includes fuel in a liquid state such as methanol, ethanol and petroleum, and the oxidizer includes air or oxygen gas, etc. The electricity generating unit 110 can be a stack structure where a plurality of fuel cells, each comprise a membrane electrode assembly (MEA), are stacked, with a separator therebetween. Herein, the membrane electrode assembly has a structure where an anode electrode (termed, “fuel electrode” or “oxidation electrode”) and a cathode electrode (termed, “air electrode” or “reduction electrode”) are respectively attached to both sides of a polymer electrolyte membrane.

The sensor 120 is a device to measure the temperature of the electricity generating unit 110. The sensor is properly disposed on the surface or the inside of the electricity generating unit 110. The sensor 120 can be a temperature detecting device such as a conventional thermistor, a thermocouple, an infrared detector, a semiconductor bandgap temperature sensor or a shape memory alloy, etc.

The first flow path unit 131 is heated by heat generated when the electricity generating unit 110 is electrochemically reacted and includes a flow path to transmit fluid of a high temperature, that is, fluid of the electrochemical reaction temperature, discharged on the cathode side to the mixing tank 150. One end of the first flow path unit 131 is connected to the cathode outlet 114b of the electricity generating unit 110, and the other end of the first flow path unit 131 is connected to the mixing tank 150 through the recycler 137.

The second flow path unit 132 includes a flow path to supply liquid fuel to the anode side of the electricity generating unit 110. One end of the second flow path unit 132 is connected to the anode inlet 112a of the electricity generating unit 110, and the other end of the second flow path unit 132 is connected to the mixing tank 150 through a first pump 152.

The heat exchanging unit 134 exchanges thermal energy between the fluid of the high reaction temperature passing through the first flow path unit 131 and the liquid fuel passing through the second flow path unit 132. The heat exchanging unit 134 may be any one of various conventional heat exchangers to absorb heat of the fluid of the reaction temperature passing through the first flow path unit 131 and transmit the absorbed heat to the liquid fuel passing through the second flow path unit 132. Such conventional heat exchangers include a tube and shell heat exchanger, a plate and frame heat exchanger, a microchannel heat exchanger, etc.

The third flow path unit 133 does not pass through the heat exchanging unit 134 and includes a flow path to supply liquid fuel to an anode side of the electricity generating unit 110. One end of the third flow path unit 133 is connected to the anode inlet 112a of the electricity generating unit 110, and the other end of the third flow path unit 133 is connected to the mixing tank 150 through the first pump 152. The first, second and third flow path units 131, 132 and 133 may be pipes, and in particular, the first and second flow path units 131 and 132 may be pipes having a good thermal conductivity.

The flow path control valve 135 is disposed in the third flow path unit 133, to open and close a flow path of the third flow path unit 133. The flow path control valve 135 is operated in response to a control signal CS1 of the control device 140. The flow path control valve 135 may be a valve to control flow and pressure of the fluids passing through the third flow path unit 133. Also, the flow path control valve 135 may be a thermostat valve to control flow and pressure of the fluids automatically passing through the third flow path unit 133 depending on the temperature sensed from the sensor 120. In the liquid fuel type fuel cell system the control device 140 may be omitted, when the thermostat valve is used.

The recycler 137 forcibly condenses a predetermined amount of the fluid of the reaction temperature passing through the first flow path unit 131. For example, the recycler 137 condenses steam to generate water and to discharge undesired gas outward. The recycler 137 may be one of various conventional devices such as a condenser, a cooler, a radiator, etc.

The control device 140 senses a temperature signal TS measured in the sensor 120, generates a first control signal CS1 to control a state of the flow path control valve 135 in response to the sensed signal, and applies the generated signal CS1 to the flow path control valve 135. Also, the control device 140 generates a second control signal CS2 to decrease the power required by a load 160 to a predetermined value or less depending on the temperature level sensed from the sensor 120, and to transmit the generated control signal CS2 to the load 160. The control device 140 may be a valve control device, a fuel cell control device to control the electricity generating unit 110 or a valve control device connected to the fuel cell control device 140.

The mixing tank 150 recovers unreacted fuel discharged from the electricity generating unit 110 and dilutes a high concentration of the liquid fuel stored in a fuel tank 154. The mixing tank 150 is connected to the electricity generating unit 110 by the first, second and third flow path units 131, 132 and 133. Also, the mixing tank 150 is connected to the anode outlet 112b of the electricity generating unit 110 by a fourth flow path unit 138 to recover unreacted fuel on the anode side of the electricity generating unit 110. Here, the fuel stored in the mixing tank 150 is supplied to the electricity generating unit 110 by a pumping force of the first pump 152, and the liquid fuel stored in the fuel tank 154 is supplied to the mixing tank 150 by a pumping force of a second pump 156.

Meanwhile, the liquid fuel type fuel cell system may include an auxiliary power supplier (not shown) to supply power required by the peripherals of the fuel cell such as the control device 140 and the first and second pumps 152, 156, etc., when starting. The auxiliary power supplier may be a battery, a capacitor, or a supercapacitor, etc.

An operation of the liquid fuel type fuel cell system as described above is described as follows. When fuel is supplied to the anode electrode of the electricity generating unit 110, the fuel is ionized and oxidized as hydrogen ions (proton, H⁺) and electrons (e⁻) by making an electrochemical reaction in the catalyst layer. The ionized hydrogen ion is moved to a catalyst layer on the cathode through the polymer electrolytic film from the catalyst layer on the anode, and the electron is moved to the catalyst layer on the cathode side through an outside conducting wire. The hydrogen ion moved to the catalyst layer on the cathode is electrochemically reduced with oxygen in air supplied to the cathode electrode by the fan or the air pump 158 to produce heat of reaction and water. The electric energy is generated by movement of the electrons. The reactions of the electricity generating unit 110 that occur at the anode electrode with a fuel plus water mixture and at the cathode electrode can be represented by the following reaction equations:
Anode electrode: CH₃OH+H₂O→CO₂+6H⁺+6e⁻
Cathode electrode: 6H⁺+3/2O₂+6e⁻→3H₂O
Overall: CH₃OH+3/2O₂→3H₂O+CO₂ [Reaction equation 1]

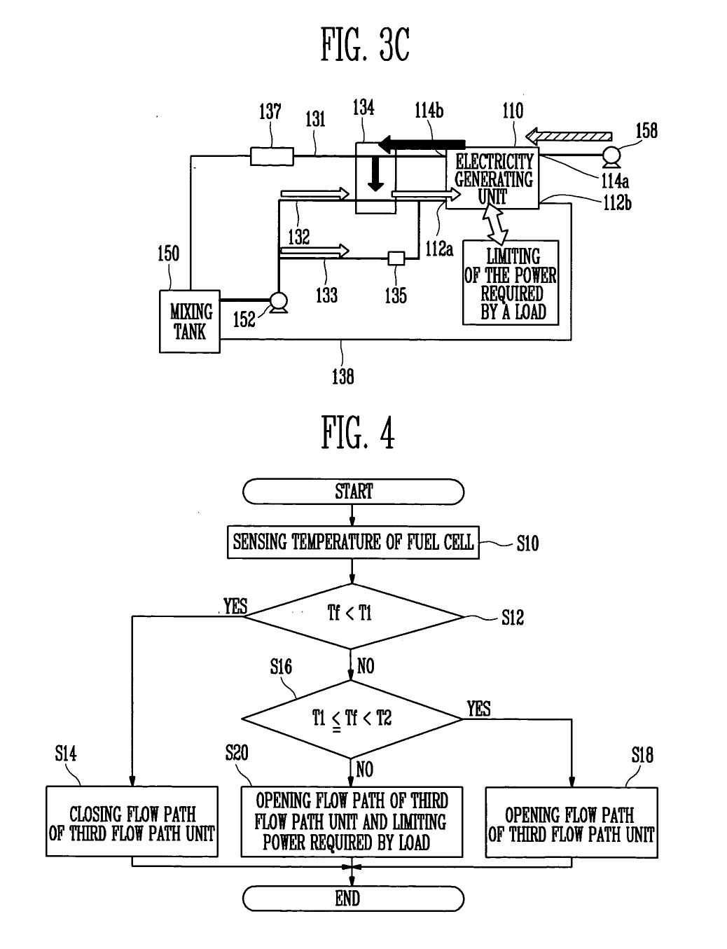

FIG. 3A to FIG. 3C are block diagrams showing three operation modes of the heat exchanger as shown in FIG. 2. Referring to FIG. 3A to FIG. 3C, the heat exchanger adopted in the liquid fuel type fuel cell system includes the second flow path unit 132 passing through the heat exchanging unit 134 and the third flow path unit 133 bypassing the heat exchanging unit 134, to supply fuel to the anode and further includes the flow path control valve 135 to control a flow path of the third flow path unit 133, which is a bypass flow path unit. Here, it is described that the control device 140 controls the flow path control valve 135 disposed on the bypass third flow path unit 133 based on a temperature of the electricity generating unit 110 detected by the sensor 120.

A reference temperature T1 is the temperature of the electricity generating unit 110 where the electricity generating unit 110 begins to show good efficiency, a critical temperature T2 is the temperature of the high temperature side of the electricity generating unit 110 where the electricity generating unit 110 begins to show bad efficiency, and the temperature detected in the electricity generating unit 110 is a sensed temperature Tf. Although the temperature of the electricity generating unit 110 is preferably measured at the inside thereof, the temperature may be measured at the anode outlet 112, etc., and used by correcting for a temperature difference between the temperature at the measured location and the temperature at the inside of the electricity generating unit 110.

First, the operation mode when the sensed temperature Tf is less than the reference temperature T1 will be described with reference to FIG. 3A. In the case of the operation mode when the sensed temperature Tf is less than the reference temperature T1, the flow path of the third flow path unit 133 is closed by the flow path control valve 135 so that most of the thermal energy of the fluid of the reaction temperature discharged from the cathode outlet 114b and passing through the first flow path unit 131 is transmitted, through the heat exchanging unit 134, to the fuel passing through the second flow path unit 132. In the case of the operation mode as above, the heated fuel is applied to the electricity generating unit 110, thereby having the effect to promptly raise the temperature of the electricity generating unit 110. Therefore, it is suitable that the operation mode as above is applied when the system is operated.

Next, the operation mode when the sensed temperature Tf is the reference temperature T1 or higher, and less than the critical temperature T2, will be described with reference to FIG. 3B. In the case of the operation mode when the sensed temperature Tf is the reference temperature T1 or higher and less than the critical temperature T2, the flow path of the third flow path unit 133 is opened by the flow path control valve 135 so that the fuel of the mixing tank 150 is divided into the second flow path unit 132 passing through the heat exchanging unit 134 and the third flow path unit 133 bypassing the heat exchanging unit 134, and then supplied to the electricity generating unit 110. Therefore, only some of the fuel supplied to the electricity generating unit 110 is heated by receiving the thermal energy from the fluid of the reaction temperature discharged from the cathode outlet 114b and passing through the first flow path unit 131 by the heat exchanging unit 134. In the case of the operation mode as above, the properly preheated fuel is supplied to the electricity generating unit 110 so that the temperature of the electricity generating unit 110 is prevented from dropping below the reference temperature T1, which is the temperature suitable for a high efficient operation, because of cold fuel during the operation of the electricity generating unit 110.

Next, the operation mode when the sensed temperature Tf is the critical temperature T2 or higher will be described with reference to FIG. 3C. In the case of the operation mode when the sensed temperature Tf is the critical temperature T2 or higher, the power required by the load 160 is limited by the control device 140 (refer to FIG. 2) in a state where the flow path of the third flow path unit 133 is opened by the flow path control valve 135. Then, the thermal energy generated in the electricity generating unit 110 is decreased by the decrease of the power required by the load, and the temperature of fluid discharged from the cathode outlet 114b is correspondingly lowered. In the case of the operation mode as described above, some fuel of low thermal energy from fluid having a lowered temperature, that is, the fuel substantially not heated, is supplied to the electricity generating unit 110, so that the temperature of the electricity generating unit 110 can easily be lowered to the temperature suitable for a high efficient operation.

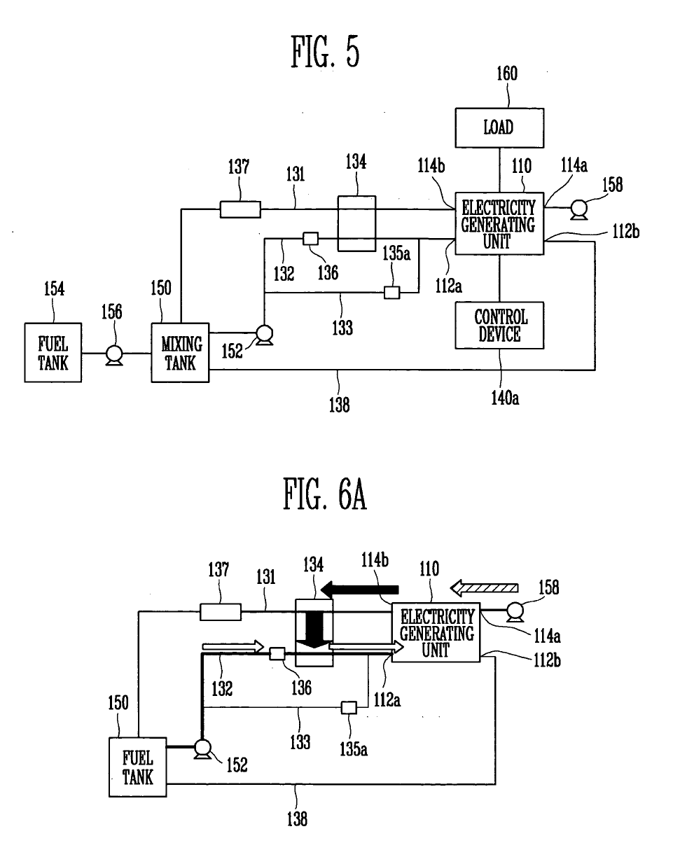

FIG. 4 is a flow chart showing the method of heat exchange of the liquid fuel type fuel cell system as shown in FIG. 2. Referring to FIG. 4, the liquid fuel type fuel cell system monitors the temperature of the electricity generating unit and periodically senses the electricity generating unit, that is, the temperature of the fuel cell (S10).

Next, whether the sensed temperature Tf is less than the reference temperature T1 is judged (S12). According to the judged result, when the sensed temperature Tf is lower than the reference temperature T1, the flow path of the third flow path unit 133 closes by controlling the flow path control valve 135 connected to the third flow path unit 133 (S14). The operation (S14) maximally exchanges thermal energy between the fluid of the reaction temperature discharged from the cathode of the electricity generating unit 110 and the fuel supplied to the anode. According to the process, the temperature of the electricity generating unit 110 is rapidly raised.

Next, according to the judged result, when the sensed temperature Tf is not less than the reference temperature T1, whether the sensed temperature Tf is the reference temperature T1 or higher and less than the critical temperature T2 is judged (S16). According to the judged result, when the sensed temperature Tf is the reference temperature T1 or higher and less than the critical temperature T2, the flow path of the third flow path unit 133 closes by controlling the flow path control valve 135 (S18). The operation is made to exchange thermal energy between the fluid of the reaction temperature discharged from the cathode of the electricity generating unit and only some of the fuel supplied to the anode. According to the process, the temperature of the electricity generating unit is maintained.

Next, according to the judged result of the operation (S16), when the sensed temperature Tf is the critical temperature T2 or higher, the control device 140 opens the flow path of the third flow path unit 133 by controlling the flow path control valve 135, and generates a control signal to limit the power required by the load 160 to a predetermined value or less and then applies the generated control signal to the load 160 (S20). The operation is made to limit exchange of thermal energy between the fluid of the reaction temperature discharged from the cathode of the electricity generating unit 110 to only some of the fuel supplied to the anode and to limit the power required by the load 160. According to such a process, the temperature of the electricity generating unit is rapidly lowered. Meanwhile, when the temperature of the electricity generating unit 110 is lower than the critical temperature T2 again, the limitation on the power required by the load 160 is released, enhancing the output of the electricity generating unit to optimum efficiency. After this, when the temperature of the electricity generating unit is lower than the reference temperature, the operation S14 is repeated.

According to the foregoing heat exchange method, advantages are that the electricity generating unit 110 can rapidly be preheated when starting and the temperature of the electricity generating unit 110 can easily be maintained at the temperature showing high efficiency during operation.

FIG. 5 is a block diagram showing a liquid fuel type fuel cell system including a heat exchanger according to a second embodiment of the present invention. Referring to FIG. 5, a liquid fuel type fuel cell system includes an electricity generating unit 110, a first flow path unit 131, a second flow path unit 132, a third flow path unit 133, a heat exchanging unit 134, a first flow path control valve 135a, a second flow path control valve 136, a recycler 137, a fourth flow path unit 138, a control device 140a and a mixing tank 150. Here, the heat exchanger is configured of a first flow path unit 131, a second flow path unit 132, a third flow path unit 133, a heat exchanging unit 134, a first flow path control valve 135a and a second flow path control valve 136.

The foregoing liquid fuel type fuel cell system is very similar to the liquid fuel type fuel cell system according to the first embodiment. However, the liquid fuel type fuel cell system according to the second embodiment differs from the liquid fuel type fuel cell system according to the first embodiment in that the second flow path control valve 136 and the control device 140a connected to the second flow path unit 132 are electrically connected to each other and the first and second flow path control valves 135, 136 may be thermostat valves, which automatically operate in response to a temperature.

Describing the second embodiment of aspects of the present invention in more detail, the first flow path control valve 135a is installed on the third flow path unit 133 to open and close the flow path of the third flow path unit 133. The first flow path control valve 135a may be the thermostat valve to automatically operate at a predetermined temperature considering a difference between a temperature of a mounting position on the third flow path unit 133 and a temperature of the electricity generating unit 110. Here, the first flow path control valve 135a as the thermostat valve is set to be closed at normal temperature and to be opened at a preset higher reference temperature. The reference temperature is the temperature of the electricity generating unit 110 where the electricity generating unit 110 begins to show good efficiency.

The second flow path control valve 136 is installed on the second flow path unit 132 to open and close the flow path of the second flow path unit 132. The second flow path control valve 136 may be the thermostat valve to automatically operate at a predetermined temperature considering a difference between a temperature of a mounting position on the second flow path unit 132 passing through the heat exchanging unit 134 and the temperature of the electricity generating unit 110. Here, the second flow path control valve 136 as the thermostat valve is set to be opened at normal temperature and to be closed at a higher preset critical temperature. The critical temperature is the temperature of a high temperature side of the electricity generating unit 110 where the electricity generating unit 110 begins to show bad efficiency.

On the other hand, the control device 140a of the present invention is not limited to a particular device, but may be any control devices capable of controlling the electricity generating unit. For example, the control device 140a may be a digital arithmetic processing unit, but is not limited thereto.

With the foregoing construction, by using the thermostat valves as the flow path control valves 135a, 136, the sensor to detect the temperature of the electricity generating unit 110 and the control device 140a to control the flow path control valves 135a, 136 may be omitted, simplifying the construction.

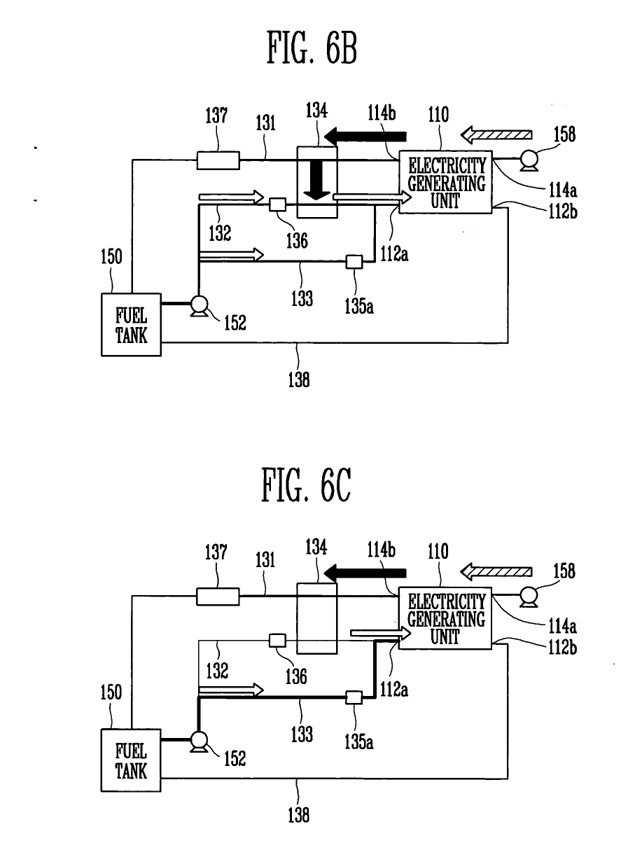

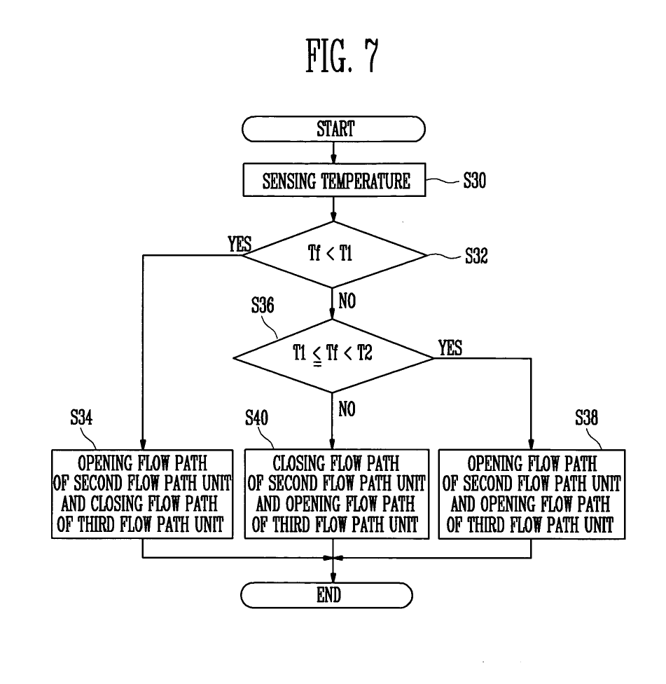

FIG. 6A to FIG. 6C are block diagrams showing three operation modes of the heat exchanger as shown in FIG. 5. Referring to FIG. 6A to FIG. 6C, a heat exchanger adopted in a liquid fuel type fuel cell system includes the second flow path unit 132 passing through the heat exchanging unit 134 and a third flow path unit 133 bypassing the heat exchanging unit 134, as a flow path unit supplying fuel to an anode and further includes the first and second flow path controlling valves 135a, 136 to control respective flow path units 132, 133. Here, the first and the second flow path control valves 135a, 136 may be thermostat valves.

First, the operation mode when the sensed temperature Tf is less than the reference temperature T1 will be described with reference to FIG. 6A. In the case of the operation mode when the sensed temperature Tf is less than the reference temperature T1, the flow path of the third flow path unit 133 is closed by the operation of the first flow path control valve 135a and the flow path of the second flow path unit 132 is opened by the operation of the second flow path control valve 136 so that most of the thermal energy of the fluid of the reaction temperature discharged from the cathode outlet 114b and passing through the flow path of the first flow path unit 131 is transferred, through the heat exchanging unit 134, to the fuel passing through the flow path of the second flow path unit 132. In the case of the operation mode as above, the heated fuel is applied to the electricity generating unit 110, thereby having the effect to promptly raise the temperature of the electricity generating unit 110.

Next, the operation mode when the sensed temperature Tf is the reference temperature T1 and higher, and less than the critical temperature T2, will be described with reference to FIG. 6B. In the case of the operation mode when the sensed temperature Tf is the reference temperature T1 or higher, and less than the critical temperature T2, in the state where the flow path of the second flow path unit 132 is opened, the flow path of the third flow path unit 133 is opened by the flow path control valve 135a so that the fuel of the mixing tank 150 is divided into the second flow path unit 132 passing through the heat exchanging unit 134 and the third flow path unit 133 bypassing the heat exchanging unit 134, and then supplied to the electricity generating unit 110. Therefore, only some of the fuel supplied to the electricity generating unit 110 is heated by receiving the thermal energy from the fluid of the reaction temperature discharged from the cathode outlet 114b and passing through the first flow path unit 131 by the heat exchanging unit 134. In the case of the operation mode as above, the properly preheated fuel is supplied to the electricity generating unit 110 so that the temperature of the electricity generating unit 110 can be maintained to be suitable for a high efficient operation during the operation of the electricity generating unit 110.

Next, the operation mode when the sensed temperature Tf is the critical temperature T2 or higher will be described with reference to FIG. 6C. In the case of the operation mode when the sensed temperature Tf is the critical temperature T2 or higher, the flow path of the third flow path unit 133 is opened by the first flow path control valve 135a and the flow path of the second flow path unit 132 is closed by the operation of the second flow path control valve 136, to supply non-heated fuel to the electricity generating unit 110. In the case of the operation as described above, the non-heated fuel is supplied to the electricity generating unit 110 so that the temperature of the electricity generating unit 110 can easily be lowered to the temperature suitable for a high efficient operation.

FIG. 7 is a flow chart showing the method of heat exchange of the liquid fuel type fuel cell system as shown in FIG. 5. Referring to FIG. 7, in the liquid fuel type fuel cell system, two thermostat valves respectively installed on the third flow path unit 133 and the second flow path unit 132 as the first and second flow path control valves 135a, 136 automatically sense the temperature of their respective mounting positions (S30). A temperature preset to operate each thermostat valve is preset considering a difference between a temperature of each respective mounting position and the temperature of the electricity generating unit.

Next, whether the sensed temperature Tf is less than the reference temperature T1 is judged (S32). According to the judged result, when the sensed temperature Tf is less than the reference temperature T1, the flow path of the third flow path unit 133 closes by controlling the first flow path control valve 135a connected to the third flow path unit 133 and the flow path of the second flow path unit 132 opens by controlling the second flow path control valve 136 connected to the second flow path unit 132 (S14). According to the process, the fuel supplied to the electricity generating unit 110 passes through the heat exchanging unit 134 to make heat exchange between fluid of the reaction temperature discharged from the cathode and fuel supplied to the anode of the electricity generating unit 110 so that the electricity generating unit 110 can naturally be preheated and operated at high efficiency.

Next, according to the judged result, when the sensed temperature Tf is not less than the reference temperature T1, whether the sensed temperature Tf is the reference temperature T1 or higher and less than the critical temperature T2 is judged (S36). According to the judged result, when the sensed temperature Tf is the reference temperature T1 or higher and less than the critical temperature T2, the flow path of the third flow path unit 133 and the flow path of the second flow path unit 132 are opened, by controlling the flow path control valves 135a, 136 (S38). According to such a process, a temperature rising of the electricity generating unit 110, caused by a high load operation and a long time operation, is suppressed due to some fuel supplied to the electricity generating unit 110 through the bypass flow path unit, i.e., the third flow path unit 133. Therefore, the temperature of the electricity generating unit 110 can be maintained so the electricity generating unit 110 can perform at optimum efficiency. On the other hand, when the temperature of the electricity generating unit 110 is lower than the reference temperature T1 again, the operation (S34) may be repeated.

Next, according to the judged result of the operation (S36), when the sensed temperature Tf is the critical temperature T2 or higher, the control device 140a opens the flow path of the third flow path unit 133 by controlling the first flow path control valve 135a and closes the flow path of the second flow path unit 132 by the second flow path control valve 136 (S20). According to the process, the temperature of the electricity generating unit can rapidly be lowered from the critical temperature T2 or higher to the temperature showing optimum efficiency.

According to the foregoing heat exchange method, advantages are that the electricity generating unit 110 can rapidly be preheated when starting and the temperature of the electricity generating unit 110 can easily be maintained at the temperature showing high efficiency during operation, while rapidly lowering the temperature of the electricity generating unit 110 to a proper temperature when the temperature of the electricity generating unit 110 rises excessively.

Meanwhile, a type of a membrane structure of the fuel cell using liquid fuel as the electricity generating unit described above can properly be selected in accordance with an environment of the fuel cell system. Further, the first and/or second valves can be implemented as one valve for controlling flow ratio of fluids passing through the second flow path unit and the third flow path unit.

As described above, when a fuel cell system adopts the heat exchanger and a method of controlling heat exchange according to aspects of the present invention, it is possible to rapidly preheat a fuel cell when starting and maintain the fuel cell at a preferred temperature during operation. Therefore, the internal temperature and operation environment of a liquid fuel type fuel cell system can be optimized. Further, the fuel cell system can stably and continuously be operated.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A heat exchanger of a liquid fuel type fuel cell system including an electricity generating unit to generate electricity by an electrochemical reaction between fuel supplied to an anode and oxidizer supplied to a cathode, the heat exchanger comprising:
a first flow path unit connected to an outlet on the cathode;
a second flow path unit connected to an inlet on the anode;
a heat exchanging unit to exchange thermal energy between fluids passing through the first flow path unit and the second flow path unit; and
a third flow path unit connected to the inlet on the anode and bypassing the heat exchanging unit.

2. The heat exchanger as claimed in claim 1, further comprising a first valve to control a flow ratio of fluids passing through the second flow path unit and the third flow path unit.

3. The heat exchanger as claimed in claim 2, wherein the first valve opens and closes a flow path of the third flow path unit.

4. The heat exchanger as claimed in claim 2, wherein the first valve is in a closed state while the temperature of the electricity generating unit is less than a reference temperature.

5. The heat exchanger as claimed in claim 4, wherein the first valve is in an open state while the temperature of the electricity generating unit is the reference temperature or higher, and below a critical temperature.

6. The heat exchanger as claimed in claim 5, wherein the first valve is a thermostat type valve to automatically open and close depending on a temperature thereof.

7. The heat exchanger as claimed in claim 2, further comprising:
a control device connected to the liquid fuel type fuel cell to control the first valve; and
a valve control device connected to the control device.

8. The heat exchanger as claimed in claim 2, further comprising a second valve to open and close a flow path of the second flow path unit.

9. The heat exchanger as claimed in claim 8, wherein the first valve is in a closed state and the second valve is in an open state while the temperature of the electricity generating unit is less than a reference temperature.

10. The heat exchanger as claimed in claim 9, wherein the first valve and the second valve are in an open state while the temperature of the electricity generating unit is the reference temperature or higher, and below a critical temperature.

11. The heat exchanger as claimed in claim 10, wherein the first valve and the second valve are in respective partial open states while the temperature of the electricity generating unit is the reference temperature or higher, and below a critical temperature, to regulate the temperature of the fluid supplied to the anode.

12. The heat exchanger as claimed in claim 10, wherein the first valve is in an open state and the second valve is in a closed state while the temperature of the electricity generating unit is the critical temperature or higher.

13. The heat exchanger as claimed in claim 12, wherein at least one of the first valve and the second valve is a thermostat type valve being automatically opened and closed depending on the temperature.

14. The heat exchanger as claimed in claim 12, further comprising a control device to control respective opening and closing operations of the first valve and the second valve.

15. A method of heat exchange of a liquid fuel type fuel cell system in a heat exchanger including a first flow path unit connected to an outlet on a cathode of a fuel cell; a second flow path unit connected to an inlet on an anode of the fuel cell; and a third flow path unit connected to the inlet on the anode and bypassing a heat exchanging unit to exchange thermal energy between fluids passing through the first flow path unit and the second flow path unit, the heat exchange method comprising:
sensing a temperature of an electricity generating unit;
controlling a flow path of the third flow path unit to be in a closed state, when the temperature of the electricity generating unit is below a reference temperature; and
controlling a flow path of the third flow path unit to be in an open state, when the temperature of the electricity generating unit is the reference temperature or higher, and below a critical temperature.

16. The method of heat exchange of a liquid fuel type fuel cell system as claimed in claim 15, further comprising transmitting a control signal to limit the power required by a load connected to the electricity generating unit to a predetermined value or less to the load, when the temperature of the electricity generating unit is the critical temperature or higher.

17. The method of heat exchange of a liquid fuel type fuel cell system as claimed in claim 15, further comprising:
controlling a flow path of the second flow path unit to be in an open state, when the temperature of the electricity generating unit is below the reference temperature; and
controlling the flow path of the second flow path unit to be in an open state, when the temperature of the electricity generating unit is the reference temperature or higher, and below the critical temperature.

18. The method of heat exchange of a liquid fuel type fuel cell system as claimed in claim 17, further comprising:
controlling the flow path of the third flow path unit to be in a partially open state, when the temperature of the electricity generating unit is the reference temperature or higher, and below a critical temperature; and
controlling the flow path of the second flow path unit to be in a partially open state, when the temperature of the electricity generating unit is the reference temperature or higher, and below the critical temperature.

19. The method of heat exchange of a liquid fuel type fuel cell system as claimed in claim 17, further comprising: controlling the flow path of the second flow path unit to be in a closed state and controlling the flow path of the third flow path unit to be in an open state, when the temperature of the electricity generating unit is the critical temperature or higher.

20. The method of heat exchange of a liquid fuel type fuel cell system as claimed in claim 19, wherein the controlling the respective flow paths of the flow path units to be a in closed or open states comprises automatically opening or closing a respective flow path of the flow path units by using thermostat type valves depending on the temperature of the electricity generating unit.

21. A liquid fuel type fuel cell system comprising:
an electricity generating unit, comprising an electrolyte membrane and an anode electrode and a cathode electrode respectively positioned on both sides of the electrolyte membrane, the electricity generating unit to generate electricity by an electrochemical reaction between liquid fuel supplied to the anode electrode and oxidizer supplied to the cathode electrode;
a sensor to sense the temperature of the electricity generating unit; and
a heat exchanging unit comprising:
a first flow path unit connected to an outlet on the cathode of the electricity generating unit, and
a second flow path unit connected to an inlet on the anode of the electricity generating unit,
a third flow path unit connected to the inlet on the anode and bypassing the heat exchanging unit, and a first control member to select a main flow path of fluids passing through the second flow path unit and the third flow path unit.

22. The liquid fuel type fuel cell system as claimed in claim 21, further comprising a second control member to control a flow path of the second flow path unit.

23. The liquid fuel type fuel cell system as claimed in claim 21, further comprising a control device to control the first and second control members to control respective flow paths of the third and second flow path units in response to the temperature sensed by the sensor.

24. The liquid fuel type fuel cell system as claimed in claim 23, wherein the control device supplies a control signal to limit a power required by a load using electricity of the electricity generating unit below a predetermined value to the load, when the temperature of the electricity generating unit is a critical temperature or higher.

25. The liquid fuel type fuel cell system as claimed in claim 23, wherein the first and second control members to control respective flow paths of the third and second flow path units comprise thermostat type valves automatically controlled depending on temperatures sensed at the respective first and second control members.

26. The liquid fuel type fuel cell system as claimed in claim 21, wherein the first flow path unit is connected to a mixing tank to store the liquid fuel of a predetermined concentration through a condenser, and the second and third flow path units are connected to the mixing tank through a pump.

27. The liquid fuel type fuel cell system as claimed in claim 26, wherein the liquid fuel is methanol.

28. A method of exchanging heat in a liquid fuel type fuel cell, the method comprising:
sensing a temperature of the liquid fuel type fuel cell;
comparing the sensed temperature to a reference temperature; and
exchanging heat between output flow from a cathode of the liquid fuel type fuel cell and input flow of an anode of the liquid fuel type fuel cell in proportion to the comparison.

29. A heat exchanger of a liquid fuel type fuel cell, comprising:
a sensor to sense a temperature of the liquid fuel type fuel cell;
a control device to compare the sensed temperature to first and second reference temperatures and to generate a signal in proportion to the comparison; and
a heat exchanging unit to transfer thermal energy from an output flow from a cathode of the liquid fuel type fuel cell to an input flow of an anode of the liquid fuel type fuel cell in response to the signal.

30. A heat exchanger of a liquid fuel type fuel cell, comprising:
an output flow member from a cathode of the liquid fuel type fuel cell;
an input flow member of an anode of the liquid fuel type fuel cell; and
a heat exchanging unit to transfer thermal energy from the output flow member from the cathode of the liquid fuel type fuel cell to the input flow member of the anode of the liquid fuel type fuel cell when a temperature of the liquid fuel type fuel cell is below a reference temperature.
